(19) United States
(12) Patent Application Publication
(10) Pub. No.: US 2015/0188991 A1
(43) Pub. Date: Jul. 2, 2015

(54) SIMULATED TETHERING OF COMPUTING DEVICES

(71) Applicant: Google Inc., Mountain View, CA (US)

(72) Inventors: Jonathan HUANG, Sunnyvale, CA (US); Paul Allan COVELL, San Francisco, CA (US)

(73) Assignee: Google Inc., Mountain View, CA (US)

(21) Appl. No.: 14/145,424

(22) Filed: Dec. 31, 2013

(51) Int. Cl. H04L 29/08

(52) U.S. Cl. CPC H04L 67/10

(57) ABSTRACT

Various aspects of the subject technology relate to systems, methods, and machine-readable media for simulating tethering of computing devices. A system is configured to updating, via communications with a server over a network, application data stored in a memory and receiving, from an offline device, a request for application data for a second application running on the offline device. In response to receiving the request, the system transmits, to the offline device, the application data requested for the first application running on the virtual tethering device, wherein the application data is configured to be used by the second application data running on the offline device.

### BACKGROUND

The present disclosure generally relates to network communications between computing devices and, in particular, to providing data to one computing device through another computing device.

In some cases, computing devices may use tethering techniques in order to provide network communications for one device through a second device. For example, the first device may not have an available network connection or the user of the first device may not wish to connect directly to a network. Instead, the second device may be configured to receive network requests from the first device, relay the network requests to the appropriate destination using communication channels established by the second device, and forward to the first device any communications addressed to the first device from the network. The user may further configure the first device to transmit any requests to the network to the second device and receive communications from the network via the second device.

### SUMMARY

Various aspects of the subject technology relate to a system comprising one or more processors, a memory configured to store application data for a first application running on the system, and a machine-readable medium comprising instructions stored therein, which when executed by the one or more processors, cause the one or more processors to perform operation. The operations include updating, via communications with a server over a network, the application data stored in the memory, receiving, from an offline device, a request for application data for a second application running on the offline device, and transmitting, to the offline device, the application data requested for the first application running on the virtual tethering device, wherein the application data is configured to be used by the second application data running on the offline device.

Some aspects of the subject technology relate to a method comprising transmitting, to a server on a network, a request for application data for a first application running on a virtual tethering device, receiving, from the server, application data for the first application running on the virtual tethering device, and storing, on a memory, the application data requested for the first application running on the virtual tethering device. The method further includes receiving, from an offline device, a request for application data for a second application running on the offline device and transmitting, to the offline device, the application data requested for the first application running on the virtual tethering device, wherein the application data is configured to be used by the second application data running on the offline device.

Other aspects relate to a machine-readable medium including instructions stored therein, which when executed by a machine, cause the machine to perform operations including transmitting, to a server on a network, a request for application data for a first application running on the system, receiving application data for the first application, and storing, in the memory, the application data requested for the first application. The operations further include receiving, from an offline device, a request for application data for a second application running on the offline device, wherein the second application is associated with the first application and transmitting, to the offline device, the application data requested for the first application running on the virtual tethering device, wherein the application data is configured to be used by the second application data running on the offline device.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding of the subject technology and are incorporated in and constitute a part of this specification, illustrate disclosed aspects of the subject technology and together with the description serve to explain the principles of the subject technology.

FIG. 1 is a conceptual block diagram illustrating an example network environment, in accordance with various aspects of the subject technology.

FIG. 2 is a data flow diagram illustrating systems and method for simulating a tethered environment, in accordance with various aspects of the subject technology.

FIG. 3 is a flow chart illustrating an example process for simulating a tethered environment, in accordance with various aspects of the subject technology.

FIG. 4 is a block diagram illustrating a computer system with which any of the machines or servers described herein may be implemented, in accordance with various aspects of the subject technology.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. In some instances, well-known structures and components are shown in block diagram form in order to avoid obscuring the concepts of the subject technology.

Various aspects of the subject technology relate to simulating a tethered environment between two or more computing devices. Computing devices are commonly configured to connect to a network (e.g., the Internet) through one or more pathways and different computing devices may be configured to connect to the network using different pathways. For example, a desktop computer or laptop may be able to connect to a network through a wired Ethernet cable and/or a Wi-Fi connection. A tablet, smartphone, or other mobile device may be able to connect to the network through a Wi-Fi connection and, in some cases, via a cellular network (e.g., a 3G or 4G network).

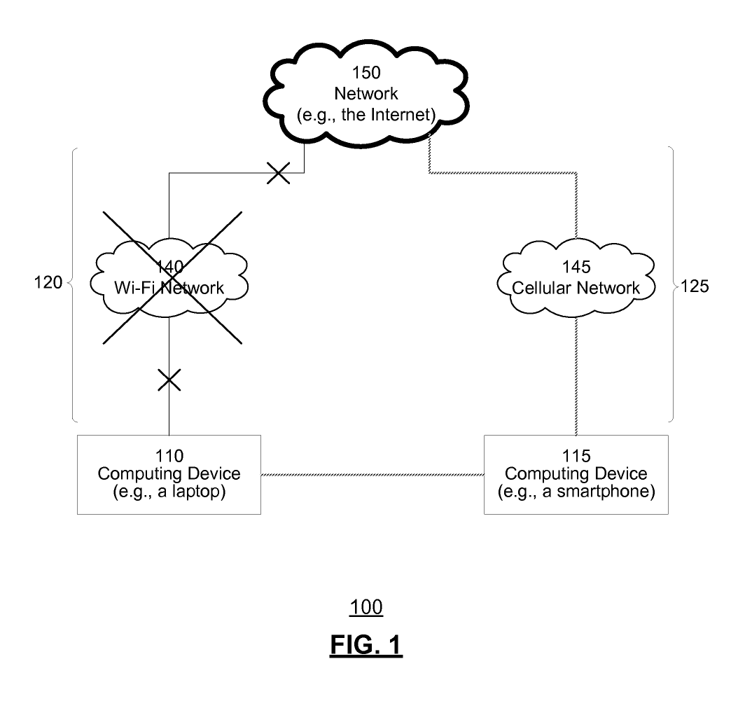

FIG. 1 is a conceptual block diagram illustrating an example network environment 100, in accordance with various aspects of the subject technology. The network environment includes two or more computing devices 110 and 115, a network 150 (e.g., the Internet), and one or more communication channels 120 and 125 for the computing devices 110 and 115 to connect to the network 150.

The computing devices 110 and 115 may include any computing machine capable of communicating with other computing machines. For example, a computing device may be a desktop computer, a laptop, a mobile device (e.g., a smart phone, tablet, personal digital assistant (PDA), a global positioning system (GPS) device, etc.), a smart display or other appliance, or any other machine with a processor, memory, and communications capabilities. Each client device may also include one or more computer programs or applications installed on a memory (e.g., a hard disk drive).

Each computing device may be capable of connecting to the network 150 through one or more communications channels. Communications channels may include, for example, a wired Ethernet line, a Wi-Fi network 140, a cellular network 145, a Bluetooth connection, a combination of different communication channels, or any other types of data communication channels. However, computing devices may not use the same communication channels to connect to the network 150. For example, in the scenario shown in FIG. 1, the computing device 110 may be a laptop configured to be able to connect to the internet through a communications channel that includes wired connection (not shown) or through a communications channel 120 that includes a Wi-Fi network 140 connected to the internet. Computing device 115, on the other hand, may be a mobile device (e.g., a smartphone) configured to be able to connect to the internet through a communications channel 120 that includes a Wi-Fi network 140 or a communications channel 125 that includes cellular network 145 connected to the internet.

Tethering occurs when, for example, one computing device 110 (e.g., a laptop), is unable to connect to the network 150 (e.g., the Internet) using a communications channels (e.g., communications channel 120) that the computing device is capable of using. Accordingly, the computing device 110 may leverage the capabilities of another computing device 115 (e.g., a smartphone or a tablet) and connect to the network 150 using an available communications channels (e.g., communications channel 125) of that device 115. The second computing device 115 may share its network connection with the first computing device 110 and communications to and from the computing device 110 are routed through the second computing device 115 to the network 150.

However, tethering devices causes the tethered device (e.g., the smartphone computing device 115 in FIG. 1) to transmit and receive additional data, which may be charged for by a network service provider (e.g., a cellular network 145 service provider). Furthermore, some network service providers may prohibit tethering of devices that they offer service to or charge extra for tethering.

According to various aspects of the subject technology, a system may be configured to simulate a tethered environment between two or more computing devices and create a virtual tethered environment. For example, computing device 110, which may not be able to communicate with the network 150 directly, may synchronize already downloaded application data stored on computing device 115, which serves as a virtual tethering device.

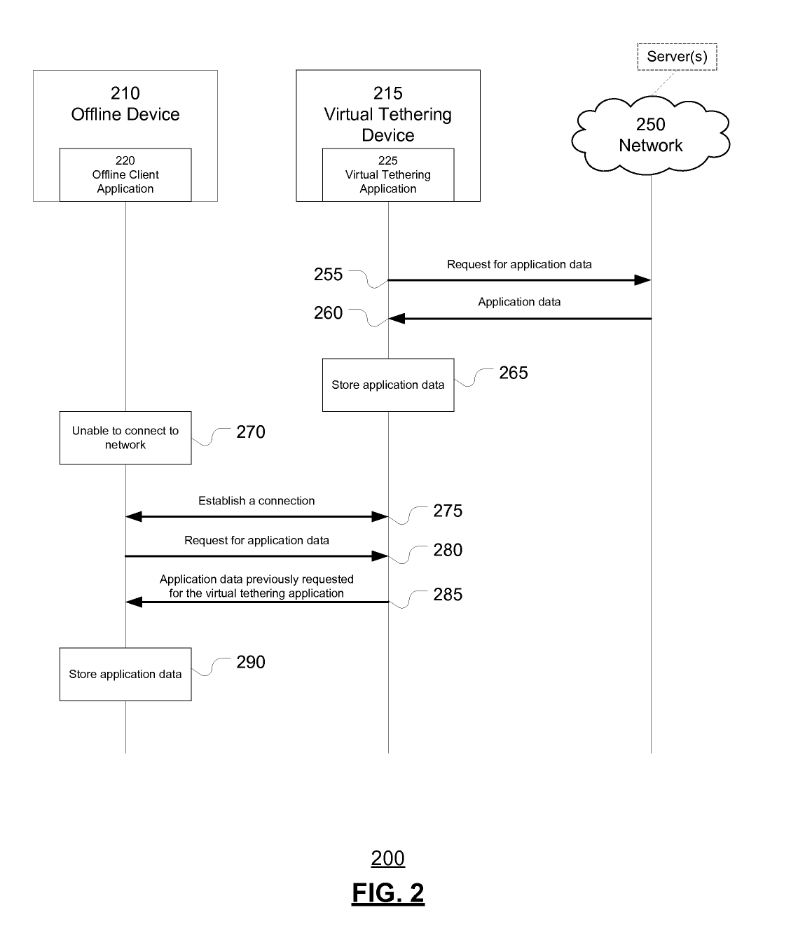

FIG. 2 is a data flow diagram 200 illustrating systems and method for simulating a tethered environment, in accordance with various aspects of the subject technology. The tethered environment may include an offline device 210, a virtual tethering device 215, and a network 250, such as the Internet. The virtual tethering device 215 may be a computing device that has a viable communications channel or pathway (e.g., via a cellular network) that is able to communicate with the network 250. The offline device 210, on the other hand, may be a computing device that is unable to connect to the network 250.

The offline device 210 may include an offline client application 220. The offline client application 220 may be any application configured to use application data from a server on the network 250. The offline application 220 may be configured to operate in an environment where the offline device 210 is unable to connect to the network, be an offline version of another application on the offline device 210, or be a portion (e.g., an “offline mode”) of an application on the offline device 210. For example, the offline device 210 may include an email application, a calendaring application, a news reader, a media player, a social networking application, or any other application configured to use application data from a server. When network access is unavailable, however, the application may go into an “offline” mode. The offline application 220 may be an “offline” mode of an application.

The virtual tethering device 215 may include a virtual tethering application 225. The virtual tethering application 225 may be any application configured to request and retrieve application data from a server on the network 250 for use on the virtual tethering device as well as provide an interface for the offline application 220 on the offline device 210 to request and retrieve application data stored on the virtual tethering application 225. The virtual tethering application 225 may be a version of, for example, an email application, a calendaring application, a news reader, a media player, a social networking application, or any other application configured to use application data from a server. Although the examples below are described with respect to an email application for the sake of clarity, aspects of the subject technology may be similarly implemented for other types of applications.

According to some aspects of the subject technology, the virtual tethering application 225 running on the virtual tethering device 215 may request application from one or more servers on the network 250. For example, the virtual tethering application 225 may be an email application that requests application data in the form of, for example, emails for a particular email account from an email server on the network 250 (e.g., the Internet). The application data may be requested by the virtual tethering application 225 (as shown at 255 of FIG. 2) or, in other aspects of the subject technology pushed to the email application from the email server without the virtual tethering application 225 making a request. At 260, the virtual tethering application 225 receives application data from one or more servers on the network 250.

Once the application data is received by the virtual tethering application 225, the virtual tethering application 225 may store the application data on the virtual tethering device 215 at 265. The stored application data may be used by the virtual tethering application 225 (e.g., the email application) or other applications on the virtual tethering device 215. For example, a user of the virtual tethering device 215 may view newly received emails or other content via the email application.

At 270, the offline client application 220 on the offline device 210 may determine that the offline device 210 is unable to directly connect to the network 250. In response to the determination, the offline client application 220 may establish a connection with the virtual tethering application 225. For example, the offline client application 220 may search for possible tethering devices that the offline device 210 may communicate with via an available communications channel (e.g., Wi-Fi, Bluetooth, other near-field communications channels, etc.). If a device is found, the offline client application 220 may send a request to the potential tethering device to determine whether the potential tethering device has an appropriate virtual tethering application that the offline client application 220 may communicate with.

If the potential tethering device sends an indication to the offline client application 220 that the potential tethering device has an appropriate virtual tethering application (e.g., virtual tethering application 225) that the offline client application 220 may communicate with, the offline client application 220 may attempt to establish a connection with the virtual tethering application at 275. For example, in order for an offline client application 220 in the form of an email application to establish a connection with an email application on the virtual tethering device 215, the email application on the virtual tethering device 215 may require that a user turn on virtual tethering capabilities of the email application. Furthermore, the email application on the offline device 210 may be configured to authenticate an email account for which application data is desired.

Once a connection is established, at 280, the offline client application 220 may transmit a request for application data for the email account to the virtual tethering application 225. In response to receiving the request, the virtual tethering application 225 may retrieve the requested application data from memory and transmit the requested application data to the offline client application at 285.

Once the application data is received by the offline client application 220, at 290, the offline client application 220 may store the application data on the offline device 210 for use by the offline client application 220. For example, a user of the offline device 210 may view newly received emails for the email account via the offline client application 220.

As a result of the virtual tethered environment being established, an offline client application 220 may appear to a user to be connected to the network 250 and the offline client application 220 may act as if it was connected to the network 250. If the offline client application 220 is to send data (e.g., sent emails, queries, instructions, or other data) to a destination on the network 250 (e.g., the email server), the data may be routed to the virtual tethering application 225 for delivery to the destination either immediately, on a schedule, or in response to an event or condition detected by the virtual tethering application 225.

A virtual tethered environment enables an offline device 210 that is unable to connect to a network 250 on its own to receive application data that is more up-to-date than the application data currently on the offline device 210. Furthermore, less data and bandwidth may be used by the tethering device 215 because the tethering device 215 serves application data that has already been received or is requested for the virtual tethering application on the tethering device 215. Furthermore, according to some aspects, the virtual tethered environment may be established for particular applications rather than the entire device as a whole. Accordingly, service providers may not charge or prohibit virtual tethering systems and processes as they might for other tethering systems.

Although in some discussed aspects of the subject technology, the offline device 210 is unable to connect to the network 250 while the virtual tethering device 215 is able to connect to the network 250, according to other aspects, both the offline device 210 and the virtual tethering device 215 may be unable to connect to the network 250. Accordingly, the tethering device 215 also does not need to be connected to the network 250. Instead, the tethering device 215 may transmit application data already stored on the tethering device 215 to the offline device 210 if the application data is more up-to-date than the version of application data on the offline device 210.

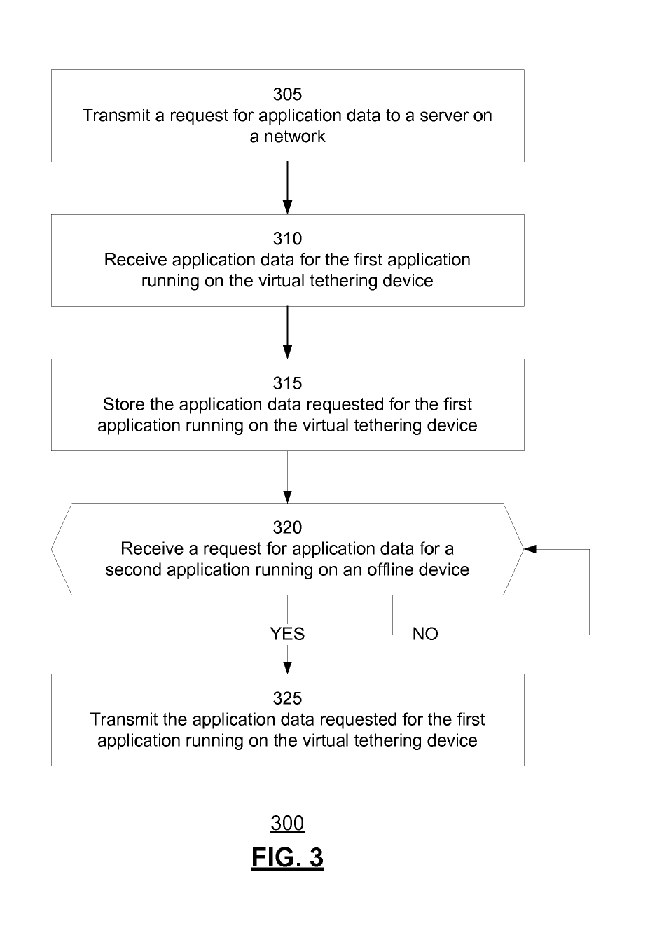

FIG. 3 is a flow chart illustrating an example process 300 for simulating a tethered environment, in accordance with various aspects of the subject technology. Although the blocks in process 300 are shown in one particular order, certain blocks may be executed in different orders or at the same time. Furthermore, although the blocks in the process 300 are described as being executed by the virtual tethering device 215 of FIG. 2, the blocks may also be executed by other computing devices.

A first application (e.g., a virtual tethering application 225) running on a virtual tethering device 215 may be configured to update application data stored in a memory. The application data may be updated through communications with a server over a network using one or more communications channels available to the virtual tethering device 215. For example, at block 305, a first application (e.g., a virtual tethering application 225) running on a virtual tethering device 215 may transmit a request for application data to a server or other destination on a network 250.

The application data may include, for example, email data, calendaring data, published content items (e.g., textual content, video content, audio content, or other content), social networking data (e.g., posts, updates, or other content, from entities in a user's social network), game data, or any other application data retrievable from a server. At block 310, the virtual tethering application 225 may receive the application data over the network 250 from the server and, at block 315, store the requested application data on a memory (e.g., a hard disk or other memory device) accessible by the virtual tethering device 215.

Once stored, the application data may be used for any reason by the virtual tethering application 225 or any other application on the virtual tethering device 215 with authorization to use the application data. For example, email or calendaring data may be used by an email application or published content items may be used by a media player, news reader, or social networking application.

At some point after the application data is stored, at block 320, the virtual tethering application 225 may determine if a request for application data compatible with a second application (e.g., an offline client application 220) running on an offline device 210 has been received. An offline device 210 may be any device unable to connect directly to the network 250. According to some aspects of the subject technology, the offline device 210 may be unable to directly connect to the network because communication channels used by the offline device 210 to connect to the network 250 are not available, the communication channels are not configured to connect to the network 250, a user of the offline device 210 has chosen not to connect to the network 250 directly, or for any other reason.

If no request has been received, the virtual tethering application 225 may continue to monitor communications channels to determine if a request is received. Furthermore, the virtual tethering application 225 or other applications on the virtual tethering device 215 with authorization may continue to use the application data.

On the other hand, if a request for application data for application data compatible with a second application (e.g., an offline client application 220) running on an offline device 210 is received, at block 325, the virtual tethering application 225 may transmit the application data requested for the first application (e.g., a virtual tethering application 225) running on a virtual tethering device 215 to the second application (e.g., an offline client application 220) running on an offline device 210. The application data transmitted to the second application may then be used by the second application data running on the offline device 210. For example, email or calendaring data may be used by an email application on the offline device 210 or published content items may be used by a media player, news reader, or social networking application on the offline device 210.

The second application (e.g., the offline client application 220) may also be configured to generate new application data. For example, the offline client application 220 in the form of an email application may create a new email, delete an email, mark an email as read, flag an email, move an email to another folder, or issue other email commands. Other types of applications may generate other commands or content for transmitting back to the server on the network. Because the offline device 210 is unable to connect directly to the network 250, the second application may transmit the new application data to the first application (e.g., a virtual tethering application 225) running on a virtual tethering device 215.

The virtual tethering application 225 running on a virtual tethering device 215 receives the new application data from the offline device and transmits the new application data to the server for the offline device. The new application data may be transmitted to the server either immediately, on a schedule, or in response to an event or condition detected by the virtual tethering application 225.

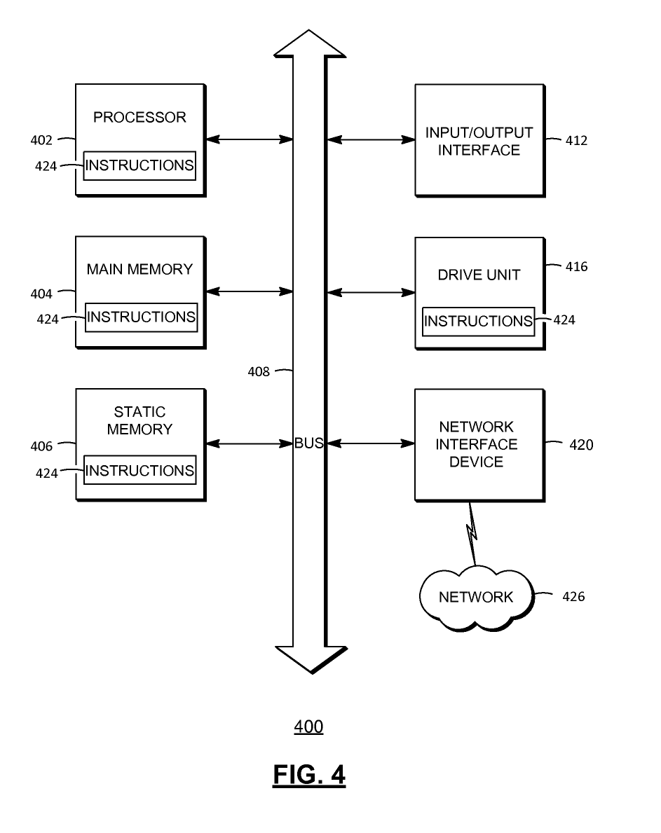

FIG. 4 is a block diagram illustrating a computer system with which any of the machines or servers described herein may be implemented, in accordance with various aspects of the subject technology. In certain aspects, the computer system 400 may be implemented using hardware or a combination of software and hardware, either in a dedicated server, or integrated into another entity, or distributed across multiple entities.

The example computer system 400 includes a processor 402, a main memory 404, a static memory 406, a disk drive unit 416, and a network interface device 420 which communicate with each other via a bus 408. The computer system 400 may further include an input/output interface 412 that may be configured to communicate with various input/output devices such as video display units (e.g., liquid crystal (LCD) displays, cathode ray tubes (CRTs), or touch screens), an alphanumeric input device (e.g., a keyboard), a cursor control device (e.g., a mouse), or a signal generation device (e.g., a speaker).

Processor 402 may be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

A machine-readable medium (also referred to as a computer-readable medium) may store one or more sets of instructions 424 embodying any one or more of the methodologies or functions described herein. The instructions 424 may also reside, completely or at least partially, within the main memory 404 and/or within the processor 402 during execution thereof by the computer system 400, with the main memory 404 and the processor 402 also constituting machine-readable media. The instructions 424 may further be transmitted or received over a network 426 via the network interface device 420.

The machine-readable medium may be a single medium or multiple media (e.g., a centralized or distributed database, and/or associated caches and servers) that store the one or more sets of instructions. The machine-readable medium may include the drive unit 416, the static memory 406, the main memory 404, the processor 402, an external memory connected to the input/output interface 412, or some other memory. The term “machine-readable medium” shall also be taken to include any non-transitory medium that is capable of storing, encoding or carrying a set of instructions for execution by the machine and that cause the machine to perform any one or more of the methodologies of the embodiments discussed herein. The term “machine-readable medium” shall accordingly be taken to include, but not be limited to, storage mediums such as solid-state memories, optical media, and magnetic media.

Systems, methods, and machine-readable media for providing an encryption key to a user are provided. The system may include a key storage module, an interface module, and an authentication module. The key storage module may be configured to store an encryption key for a user on an encryption key server, wherein the encryption key is associated with storing user data on a data storage server. The interface module may be configured to receive a request for the encryption key from a client machine associated with the user. The authentication module may be configured to authenticate the user, wherein the interface module may further be configured to transmit the encryption key to the client machine in response to authenticating the user.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that the specific order or hierarchy of steps in the processes disclosed is an illustration of example approaches. Based upon design preferences, it is understood that the specific order or hierarchy of steps in the processes may be rearranged. Some of the steps may be performed simultaneously.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such a configuration may refer to one or more configurations and vice versa.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

What is claimed is:

1. A system comprising:
one or more processors;
a memory configured to store application data for a first application running on the system; and
a machine-readable medium comprising instructions stored therein, which when executed by the one or more processors, cause the one or more processors to perform operations comprising:
updating, via communications with a server over a network, the application data stored in the memory;
receiving, from an offline device, a request for application data for a second application running on the offline device; and
transmitting, to the offline device, the application data requested for the first application running on the virtual tethering device, wherein the application data is configured to be used by the second application data running on the offline device.

2. The system of claim 1, wherein the offline device is unable to directly connect to the server on the network using communication channels available to the offline device.

3. The system of claim 2, wherein the communications channels available to the offline device comprise at least one of a wired connection of a Wi-Fi network connection.

4. The system of claim 1, further comprising a network interface configured enable communications using at least two communications channels.

5. The system of claim 4, wherein the at least two communications channels comprise at least one of a Wi-Fi network connection and a cellular communications channel.

6. The system of claim 1, wherein the updating of the application data via communications with the server is performed via a first communications channel, and wherein the application data is transmitted to the offline device via a second communications channel.

7. The system of claim 1, wherein the operations further comprise providing for the use of the application data by the first application running on the system.

8. The system of claim 1, wherein the operations further comprise losing a communications channel to the network, wherein the stored application data is transmitted to the offline device after losing the communications channel to the network.

9. The system of claim 1, wherein the operations further comprise:
receiving new application data from the offline device; and
transmitting the new application data to the server on the network.

10. The system of claim 1, wherein the first application is an email application and wherein the application data is email data.

11. A method comprising:
transmitting, to a server on a network, a request for application data for a first application running on a virtual tethering device;
receiving, from the server, application data for the first application running on the virtual tethering device;
storing, on a memory, the application data requested for the first application running on the virtual tethering device;
receiving, from an offline device, a request for application data for a second application running on the offline device; and
transmitting, to the offline device, the application data requested for the first application running on the virtual tethering device, wherein the application data is configured to be used by the second application data running on the offline device.

12. The method of claim 11, wherein the offline device is unable to directly connect to the server on the network using communication channels available to the offline device.

13. The method of claim 11, further comprising providing for the use of the application data by the first application running on the system.

14. The method of claim 11, further comprising losing a communications channel to the network, wherein the stored application data is transmitted to the offline device after losing the communications channel to the network.

15. The method of claim 11, further comprising:
receiving new application data from the offline device; and
transmitting the new application data to the server on the network.

16. A non-transitory machine-readable medium comprising instructions stored therein, which when executed by a machine, cause the machine to perform operations comprising:
transmitting, to a server on a network, a request for application data for a first application running on the system;
receiving application data for the first application;
storing, in the memory, the application data requested for the first application;
receiving, from an offline device, a request for application data for a second application running on the offline device, wherein the second application is associated with the first application; and
transmitting, to the offline device, the application data requested for the first application running on the virtual tethering device, wherein the application data is configured to be used by the second application data running on the offline device.

17. The non-transitory machine-readable medium of claim 16, wherein the offline device is unable to directly connect to the server on the network using communication channels available to the offline device.

18. The non-transitory machine-readable medium of claim 16, wherein the communications channels available to the offline device comprise at least one of a wired connection of a Wi-Fi network connection.

19. The non-transitory machine-readable medium of claim 16, wherein the request for application data is transmitted to the server on the network via a first communications channel, and wherein the application data is transmitted to the offline device via a second communications channel.

20. The non-transitory machine-readable medium of claim 16, wherein the operations further comprise providing for the use of the application data by the first application running on the system.
